(19) United States
(12) Patent Application Publication
(10) Pub. No.: US 2026/0202856 A1
(43) Pub. Date: Jul. 16, 2026

(54) AUTONOMOUS UNMANNED GROUND VEHICLE WITH DEPLOYABLE CRAWLERS FOR INTERNAL INSPECTION OF UNDERGROUND STRUCTURES

(71) Applicant: SAUDI ARABIAN OIL COMPANY, Dhahran (SA)

(72) Inventors: Ibrahim S. Alsalamah, Thuwal (SA); Fadl Abdellatif, Thuwal (SA); Brian Parrott, Thuwal (SA); Ali J. Alrasheed, Thuwal (SA); Amjad Felemban, Thuwal (SA)

(73) Assignee: SAUDI ARABIAN OIL COMPANY, Dhahran (SA)

(21) Appl. No.: 19/018,522

(22) Filed: Jan. 13, 2025

(51) Int. Cl. G05D 1/648; G05D 1/246; G05D 1/69; G05D 101/15; G05D 105/80; G05D 107/50; G05D 109/10; G05D 111/10; G05D 111/20

(52) U.S. Cl. CPC G05D 1/648; G05D 1/246; G05D 1/69; G05D 2101/15; G05D 2105/89; G05D 2107/50; G05D 2109/10; G05D 2111/10; G05D 2111/20

(57) ABSTRACT

Inspection systems for underground structures using an autonomous unmanned ground vehicle are disclosed. A representative system includes a plurality of sensors mounted on the vehicle. The sensors can be cameras, LiDAR, thermal imaging sensors, or others. A telescopic pole is mounted on the vehicle and configured to lift one or more cameras into proximity of the underground structure. A first deployable crawler is carried by the vehicle and equipped with a combination of ultrasonic testing probes, eddy current sensors, and terahertz sensors. A control system is also part of the representative system and has a processor, a memory, and code. The control system is configured to output signals to autonomously navigate the unmanned ground vehicle along the length of the underground structure and deploy one or more crawlers in response to detection of anomalies. Methods for inspecting underground structures with unmanned ground vehicles are also disclosed.

### FIELD OF THE DISCLOSURE

The present disclosure relates generally to the field of inspection and maintenance of underground structures, and more specifically to systems and methods that deploy autonomous unmanned ground vehicles equipped with multiple types of sensors and nested crawlers to perform inspection tasks and mapping.

### BACKGROUND OF THE DISCLOSURE

Underground structures, such as large cavern-shaped tanks used for storing hydrocarbon products, are critical components of modern infrastructure. Their integrity is paramount to ensuring safety, environmental protection, and operational continuity. The current inspection process for these structures is challenging and resource-intensive, typically involving manual inspections that require extensive scaffolding throughout the structure’s internal volume. Erecting this scaffolding is time-consuming and costly, but it also poses significant risks to personnel due to the inherent dangers of working at heights and in confined spaces. Current methods mandate an extensive amount of time for set-up and disassembly, increasing downtime and consequently impacting productivity and operational costs.

The complexity of inspecting such underground structures presents a need for solutions that provide coverage and analysis of these structures to identify potential issues such as corrosion, cracks, or structural weaknesses, prior to deploying human personnel. Traditional inspection methods largely rely on manual visual assessments or the use of simple imaging techniques, which may not detect subsurface defects. Furthermore, conventional processes do not offer an efficient way to track changes in the conditions of these structures over time, which is required for predictive maintenance and asset management.

The present disclosure is directed to mitigate and address these concerns.

### SUMMARY OF THE DISCLOSURE

In one or more embodiments, an inspection system for an underground structure comprises an autonomous unmanned ground vehicle. In one or more implementations, a plurality of sensors is mounted on the unmanned ground vehicle. In particular arrangements, the sensors comprise a combination selected from the group consisting of cameras, LiDAR, and thermal imaging sensors. In various arrangements, a telescopic pole is mounted on the unmanned ground vehicle. In one or more variants, the telescopic pole is configured to lift one or more cameras into proximity of the underground structure. In one or more variations, a first deployable crawler is carried by the unmanned ground vehicle. In some implementations, the first deployable crawler is equipped with a combination of sensors selected from the group consisting of ultrasonic testing (UT) probes, eddy current sensors, and terahertz sensors. In one or more implementations, a control system is also part of the system. In particular arrangements, the control system comprises a processor, a memory, and code stored in the memory and executable in the processor. In various arrangements, the control system is configured, via code executing in the processor, to output one or more control signals. In one or more variants, these signals are configured to autonomously navigate the unmanned ground vehicle along the length of the underground structure and to deploy the first deployable crawler in response to detection of anomalies in the underground structure. In one or more variations, the processor is equipped with a machine learning algorithm operative to analyze data received from one or more of the unmanned ground vehicle sensors, the first deployable crawler sensors, or both.

In some implementations, the unmanned ground vehicle is equipped with steerable wheels. In one or more implementations, the steerable wheels further comprise magnetic wheels, suction wheels, or a combination of both magnetic wheels and suction wheels. In particular arrangements, the unmanned ground vehicle comes equipped with a laser grid projector mounted on a pan-tilt mechanism. In various arrangements, the control system machine learning algorithm is configured to analyze images received by the processor in order to detect anomalies. In one or more variants, the LiDAR system generates point cloud data. In one or more variations, the control system is further configured by code to generate a map of the underground structure. In some implementations, the unmanned ground vehicle thermal imaging sensors are configured to produce a thermal map indicating temperature gradients and potential defects within the underground structure. In one or more implementations, an indoor positioning system is further included. In particular arrangements, the positioning system is configured to utilize infrared, Wi-Fi, acoustic, or vision-based tracking in order to position the unmanned ground vehicle with the underground structure. In various arrangements, the unmanned ground vehicle further comprises one or more acoustic sensors configured to capture sound wave data. In one or more variants, the unmanned ground vehicle has one or more additional deployable crawlers. In one or more variations, the unmanned ground vehicle, the first deployable crawler, and any additional deployable crawlers are configured to operate simultaneously. In some implementations, the multiple crawlers are configured to synchronize their movements.

In one or more embodiments, a method for inspecting an underground structure using an autonomous unmanned ground vehicle involves navigating the unmanned ground vehicle autonomously along the length of the underground structure using a plurality of sensors. In one or more implementations, the sensors comprise a combination selected from the group consisting of cameras, LiDAR, and thermal imaging sensors. In particular arrangements, a deployable crawler is deployed upon detection of anomalies in the underground structure by the unmanned ground vehicle sensors. In various arrangements, the deployable crawler is equipped with a combination of sensors. In one or more variants, the sensors are selected from the group consisting of an ultrasonic testing (UT) probe, an eddy current sensor, and a terahertz sensor. In one or more variations, data received from the sensors mounted on the unmanned ground vehicle and the first deployable crawler is analyzed. In some implementations, the analyzing step is performed using a control system with a processor, a memory, and code. In one or more implementations, the processor is configured to execute a machine learning algorithm. In particular arrangements, one or more control signals are output. In various arrangements, the signals are configured to direct the unmanned ground vehicle and the first deployable crawler to one or more areas of interest within the underground structure. In one or more variants, the simultaneous operation of the unmanned ground vehicle, the first deployable crawler, and any additional deployable crawlers is coordinated. In one or more variations, their movements and data collection processes are synchronized.

In one or more implementations, the method further comprises selecting at least one of magnetic wheels and suction wheels to equip the unmanned ground vehicle. In particular arrangements, the unmanned ground vehicle is adhered to surfaces of the underground structure. In various arrangements, the selection step is a function of a surface material of the underground structure. In one or more variants, the method further comprises extending a telescopic pole with one or more cameras from the unmanned ground vehicle. In one or more variations, the telescopic pole captures images of the underground structure at a telescoping distance from the unmanned ground vehicle. In some implementations, the method further comprises deploying a laser grid projector mounted on a pan-tilt mechanism from the unmanned ground vehicle. In one or more implementations, laser grids are projected on the walls of the underground structure to detect surface deformations. In particular arrangements, the method further comprises generating LiDAR point cloud data via code executing in the control system processor. In various arrangements, a map of the underground structure is constructed. In one or more variants, a thermal map is generated using thermal imaging sensors. In one or more variations, the thermal map identifies temperature gradients and potential defects within the underground structure. In some implementations, the method further comprises positioning the unmanned ground vehicle within the underground structure with a positioning system. In one or more implementations, the positioning system utilizes infrared tracking, Wi-Fi tracking, acoustic tracking, or vision-based tracking.

In particular arrangements, the method further comprises capturing sound wave propagation data with acoustic sensors mounted on the unmanned ground vehicle. In various arrangements, the method , wherein the coordinating step, further comprises commanding multiple deployable crawlers initially carried by the unmanned ground vehicle. In one or more variants, these crawlers independently inspect different sections of the underground structure upon deployment. In one or more variations, the method further comprises constructing a three-dimensional model of the underground structure. In some implementations, the model uses data collected from one or more of the cameras, LiDAR, and sensors. In one or more implementations, the method further comprises monitoring for hazardous gases via one or more gas detection sensors. In particular arrangements, updates on one or more environmental conditions within the underground structure are provided. In various arrangements, these updates come via signals relayed to the control system by the gas detection sensors.

In one or more implementations, the method further comprises navigating the unmanned ground vehicle autonomously along the underground structure with one or more of the long-range sensors in an active inspection mode. In some implementations, the active inspection mode is paused upon detection of an anomaly by the long-range sensors. In particular arrangements, at least one deployable crawler equipped with one or more of the close-range sensors is deployed in response to the detected anomaly. In various arrangements, a close-range inspection of the detected anomaly is conducted by the deployable crawler. In one or more variants, the deployable crawler returns to the unmanned ground vehicle after the close-range inspection is completed. In one or more variations, the deployable crawler is docked in the unmanned ground vehicle. In some implementations, the active inspection mode with the long-range sensors is resumed for continued navigation along the underground structure after the deployable crawler has docked.

The details of one or more implementations are set forth in the accompanying drawings and the description below. Other features will be apparent from the description, from the drawings, and from the claims.

### BRIEF DESCRIPTION OF THE DRAWINGS

The foregoing and other objects and advantages of the present disclosure will become more apparent when considered in connection with the following detailed description and appended drawings in which like designations denote like elements in the various views, in which:

FIG. 1 is an underground structure being inspected by an unmanned ground vehicle equipped with one or more sensors and deployable crawlers, consistent with one or more embodiments of the present disclosure.

FIG. 2 is a side and front view of an underground structure being inspected by an unmanned ground vehicle equipped with one or more sensors and deployable crawlers, consistent with one or more embodiments of the present disclosure.

FIG. 3 is an unmanned ground vehicle equipped with one or more sensors and a crawler being deployed, consistent with one or more embodiments of the present disclosure.

FIG. 4A is a camera array such as those used on an unmanned ground vehicle, consistent with one or more embodiments of the present disclosure. FIG. 4B is a sliding camera such as those used on an unmanned ground vehicle, consistent with one or more embodiments of the present disclosure.

FIG. 5A is a fractional laser grid cross-section projected from an unmanned ground vehicle for inspecting the wall of an underground structure, consistent with one or more embodiments of the present disclosure. FIG. 5B is a 180-degree laser grid cross-section projected from an unmanned ground vehicle for inspecting the wall of an underground structure, consistent with one or more embodiments of the present disclosure. FIG. 5C is a close-up view of a laser grid cross-section projected from an unmanned ground vehicle for inspecting the wall of an underground structure, consistent with one or more embodiments of the present disclosure.

FIG. 6 is a LiDAR sensor mounted on an unmanned ground vehicle, consistent with one or more embodiments of the present disclosure.

FIG. 7 is a series of various types of thermal cameras mounted on an unmanned ground vehicle, as well as acoustic sensors, consistent with one or more embodiments of the present disclosure.

FIG. 8 is a telescoping pole mounted on an unmanned ground vehicle, consistent with one or more embodiments of the present disclosure.

FIG. 9A is a deployable crawler descending an unmanned ground vehicle ramp, consistent with one or more embodiments of the present disclosure. FIG. 9B is a deployable crawler scaling the interior wall of an underground structure, consistent with one or more embodiments of the present disclosure.

FIG. 10 is an application of Structure from Motion (“SfM”) analysis performed by an unmanned ground vehicle and optionally one or more deployable crawlers, consistent with one or more embodiments of the present disclosure.

FIG. 11 is a set of multiple deployable crawlers conducting a synchronized dynamic scan of an underground structure, consistent with one or more embodiments of the present disclosure.

### DETAILED DESCRIPTION OF CERTAIN EMBODIMENTS CONSISTENT WITH THE DISCLOSURE

The present disclosure relates to an autonomous unmanned ground vehicle equipped with deployable crawlers designed for the internal inspection of underground structures, typically large underground cavern-shaped tanks used for storing hydrocarbons. They can be tens of meters wide and high, and hundreds of meters long. There is typically one or more access points that allow entry to the tank once it is emptied. Manual inspection of such structures has historically been laborious and expensive due to the need to erect scaffolding throughout, posing safety risks and costing significant time and resources. The present disclosure offers a system and method comprising an unmanned ground vehicle with steerable wheels carrying out inspections with a variety of mounted long-range sensors, including a camera array, laser projectors, and thermal imaging equipment. When the unmanned ground vehicle’s long-range sensors detect anomalies, it dispatches deployable crawlers with close-range sensors to perform detailed examinations of suspected problem areas. In some implementations, the unmanned ground vehicle takes a high resolution “slice” of the surrounding circumference area with multiple layers of information as a long-range sensing method.

The unmanned ground vehicle utilizes machine learning to analyze the data collected by its sensors and is configured to parse through the expansive information to identify potential structural integrity issues within the underground tanks. High-resolution imaging allows systems and methods consistent with the present disclosure to visually inspect wall surfaces, while an integrated LiDAR system maps the cavern geometry and identifies any geometric shifts that might suggest deeper issues like cracks or warping. A projected laser grid aids in visual inspections by highlighting surface deformations. Thermal imaging detects temperature gradients that may reveal hidden defects. In one or more implementations, the unmanned ground vehicle autonomously navigates on its own while carrying out these inspections, and the crawlers can attach magnetically or use suction to adhere to non-metallic surfaces, providing a comprehensive suite of inspection capabilities.

The systems and methods disclosed herein utilize a novel combination of sensing and robotic technologies to provide surprising benefits over previous methods, including more rapid inspections with reduced manpower and increased safety, as the need for scaffolding is eliminated. The unmanned ground vehicle provides a thorough pre-analysis, allowing for the efficient use of crawlers to zoom in and examine selected areas with precision. The vehicle’s array of technology detects and anticipates potential structural compromises while offering detailed 3D modeling. A primary application of the present disclosure is underground cavern tanks, but it can also be used with any cylindrical assets including tanks and horizontal vessels.

Primary embodiments of the present disclosure incorporate an autonomous hybrid underground vehicle with one or more deployable crawlers, both equipped with an array of sensors, driven inside an underground structure such as a cavern tank, driven primarily along its length, in order to inspect structural integrity, wall deformations, coating integrity, under-coating cracks, thermal anomalies, and other concerning defects. The methods by which inspection occurs are categorized based on sensor range. In most implementations, the unmanned ground vehicle will carry out long-range inspections and the deployable crawler(s) execute close-range inspection.

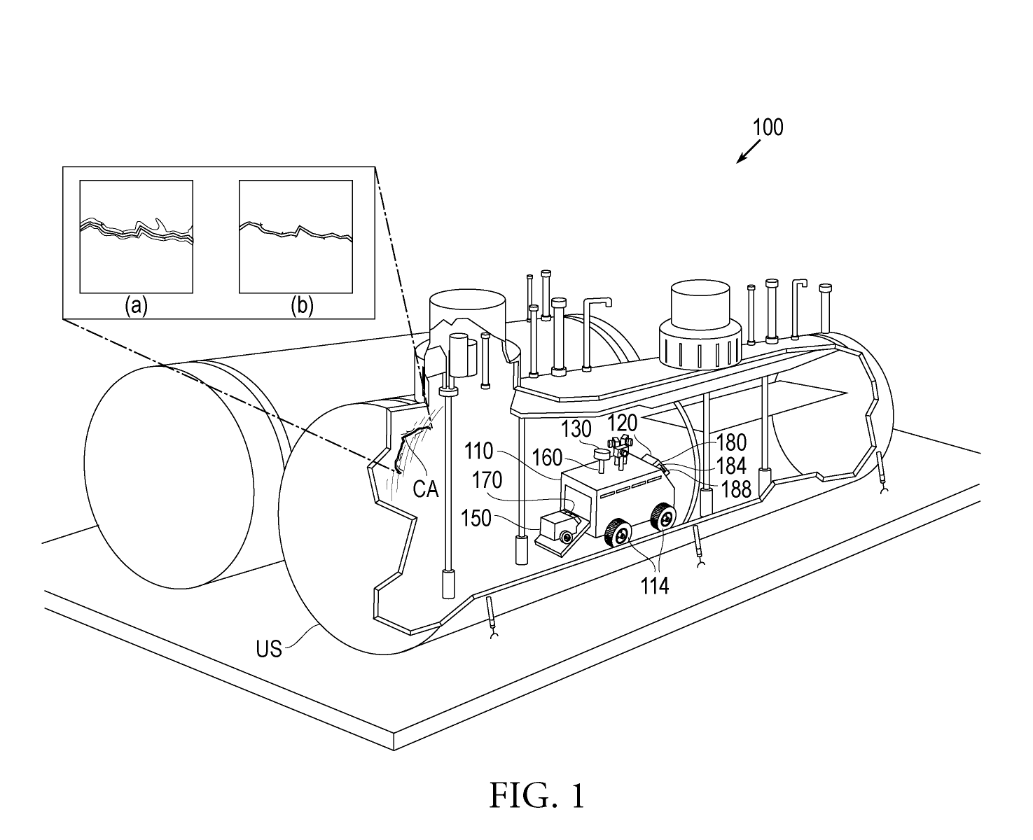

FIG. 1 is a depiction 100 of an underground structure (“US”) being inspected by an autonomous unmanned ground vehicles 110 equipped with one or more cameras 120, sensors 130, and deployable crawlers 150, consistent with one or more embodiments of the present disclosure. In some implementations, systems consistent with the present disclosure include an unmanned ground vehicle 110 with steerable wheels 114. It will be understood that “sensor 130” or “sensors 130” as referred to throughout this disclosure are in reference to one or more of a variety of possible sensors, including in some cases thermal or high-resolution cameras, LiDAR systems, acoustic sensors, thermal sensors, gas detection sensors, or others, depending on the context and the particular implementation or implementations described.

In one or more variations, systems consistent with the present disclosure feature a plurality of sensors 130 mounted on the unmanned ground vehicle 110. In some implementations, the sensors 130 include a combination selected from the group consisting of cameras 120, LiDAR, and thermal imaging sensors. In one or more variations, systems consistent with the present disclosure further comprise an unmanned ground vehicle comprising one or more acoustic sensors 130. In some implementations, these sensors are configured to capture sound wave data. In some implementations, acoustic sensors 130 are used for the detection of cracks within structural walls, by capturing and analyzing reflections or travelling waves of sound emitted against the surfaces.

In one or more variants, at least one telescopic pole 160 is mounted on the unmanned ground vehicle 110 and are further configured to extend the reach of one or more sensors 130 or cameras 120. In some implementations, a telescopic pole 160 (described further below) having a platform is employed to elevate, for example, a 360-degree array of cameras, each equipped with telephoto lenses, or other sensors, facilitating comprehensive visual or sensory inspections of structures.

In one or more variations, a first deployable crawler 150 is carried by the unmanned ground vehicle 110. In some implementations, the first deployable crawler 150 is equipped with a combination of sensors, such as sensor 170, selected from the group consisting of ultrasonic testing (UT) probes, eddy current sensors, and terahertz sensors. In some implementations, each deployable crawler 150 is fitted with infrared sensors (such as sensor 170 or another sensor) to align and synchronize scanning activities, allowing for coordinated operation among multiple crawlers 150 during simultaneous inspections.

In one or more variants, a control system 180 is stationed on or in the unmanned ground vehicle 110. In some implementations, the control system 180 comprises a processor 184, a memory 188, and code stored in the memory 188 and executable in the processor 184. In one or more variations, the control system 180 is configured, via code executing in the processor 184, to output one or more control signals. In some implementations, these signals are configured to autonomously navigate the unmanned ground vehicle 110 along the length of the underground structure (US) and deploy the first deployable crawler 150 upon detection of anomalies (such as crack anomaly “CA” in FIG. 1). In one or more variants, the processor 184 is equipped with a machine learning algorithm. In some implementations, this algorithm is operative to analyze data received from one or more of the unmanned ground vehicle 110 sensors 130, the first deployable crawler 150 having sensors 170, or both. In some implementations, the control system 180 machine learning algorithm analyzes images received by the processor 184 to detect (identify) anomalies in the underground structure (US).

In most implementations, the unmanned ground vehicle 110 drives autonomously along the length of the underground structure, such as a tank, conducting long-range inspection using, for example, a combination of the following: a high-resolution camera 120, a laser projector and reflector, a thermal camera, or other sensors. In various arrangements, the unmanned ground vehicle 110 uses artificial intelligence (AI) techniques to aid in detecting anomalies in the interior walls of the underground structure. When a defect is detected, the unmanned ground vehicle 110 pinpoints, using sensors 130 and geolocation instruments, the exact location of the defects. Once defects are pinpointed, the unmanned ground vehicle 110 releases or deploys one or more smaller deployable crawlers 150. In most implementations, these deployable crawlers 150 are equipped with close range sensors 170, comprising one or a combination of ultrasonic testing (UT), Eddy current, terahertz (THz), or other sensors. In many variations, the deployable crawler 150 is able to navigate to the location of a defect while attaching magnetically or using suction wheels (described further below).

Once the deployable crawler 150 has navigated to a defect in the underground structure, in most implementations it begins to capture data about the defect using its sensors 170 and transmit electrical signals or communicate that data with the unmanned ground vehicle 110. After sufficient data is collected on a defect, the deployable crawler(s) 150 returns to the unmanned ground vehicle 110 and reattaches, parks, or nestles inside it so the unmanned ground vehicle 110 is able to continue its navigation along the length of the underground structure while conducting long-range inspection. Long-range detection or inspection in this context refers to remote inspection from a distance. For example, one or more implementations of an unmanned ground vehicle 110 performs visual inspection using an array of high-resolution cameras, thermal inspection using infrared cameras, wall geometry profiling using LiDAR sensors, and laser projectors, along with other remote inspection and sensing techniques to quickly scan underground structure surfaces and identify anomalies that warrant closer inspection. Contact-based or close-range inspection methodologies are then performed with one or more crawlers 150 released from the unmanned ground vehicle 110.

In one or more implementations, the long-range detection method locates defects and roughly estimates the severity of anomalies with speed compared to close-range inspection, though it lacks the precision to accurately measure the size and depth of the anomaly. In various arrangements, this limitation prompts the deployment of a crawler or crawlers 150 to accurately gauge the size, depth, severity, and potential propagation of the anomaly, thereby enhancing both the efficiency and effectiveness of the inspection process. In particular arrangements, a long-range sensor 130, such as thermal imaging equipment, projects a heatmap on an operator display screen. In one or more variants, the occurrence of a sudden temperature difference or a gradient on this heatmap signals an anomaly in the area. In various arrangements, a high-resolution camera 120 is then able to zoom in and capture high-definition images, allowing for analysis to determine whether the defect exists at the surface level or at a deeper level that is not visually detectable. This example illustrates the necessity of conducting closer investigations of the anomaly with alternate technologies utilizing a robotic crawler 150.

With respect to the data analysis performed in various systems and methods consistent with the present disclosure –all of which use a processor configured by code to execute the functionality described herein in a manner understood by persons having ordinary skill in the art, in one or more implementations, Convolutional Neural Networks (CNNs) and attention-based networks are utilized for detecting anomalies in visual data collected by sensors 130 and cameras 120 on an unmanned ground vehicle 110 (or in other embodiments disclosed herein). In some implementations, these data analysis tools are deployed in the processor 184 of an unmanned ground vehicle 110 control system 180. Such models are adept at being trained to recognize deviations from typical image patterns. In one or more variations, for instance, an autoencoder-based CNN can master the normal appearance of a structure and subsequently flag any significant deviations as anomalies. In particular arrangements, PointNet or PointNet++ process the 3D point clouds generated by LiDAR sensors. These networks are suitable for learning how to detect inconsistencies in surface topology, such as cracks or misalignments, which might be indicators of structural problems.

In various arrangements, thermal imaging can also be analyzed using CNNs, attention-based networks, or even traditional machine learning methods like Support Vector Machines (SVM) following feature extraction. In one or more variations, anomalies such as hotspots or areas with unusual thermal gradients signal issues including insulation failures or moisture intrusion. In one or more implementations, for sensor fusion and anomaly detection, data-level fusion involves combining raw data from various sensors before any processing occurs. This technique demands that sensors have compatible data formats and sampling rates. For example, in some implementations, thermal and visual images along with LiDAR data are fused into multi-channel tensors that encapsulate all sensor 130 information into one mathematical variable, which is then processed using deep learning networks.

In one or more variations, at the feature level, fusion involves extracting features independently from each sensor 130’s data and then merging them into one comprehensive feature vector. In some implementations, for instance, the output from a CNN processing visual data could be concatenated with features extracted from a thermal image, and these combined features fed into a classifier like a Random Forest or another neural network. In one or more arrangements, decision-level fusion allows for each unmanned ground vehicle 110’s sensor 130’s data to be processed separately, and the resultant decisions (such as the detection of an anomaly) are combined. In various arrangements, techniques such as weighted voting, ensemble methods, or Bayesian inference are deployed to integrate these decisions into a coherent final determination.

In one or more implementations, visual images undergo normalization, resizing, and enhancement during pre-processing, such as those depicted in the close-up views (a) and (b) of crack anomaly “CA” in FIG. 1. In various arrangements, LiDAR data is subjected to noise removal and downsampling to improve processing efficiency. In some implementations, thermal images are resized and normalized to compensate for temperature discrepancies. In one or more variants, feature extraction involves the use of CNNs to derive features from visual images. In particular arrangements, PointNet is employed to extract 3D surface features from LiDAR data. In one or more variations, another CNN is tasked with processing thermal images to identify thermal anomalies. In various arrangements, the features from the CNNs and PointNet are amalgamated into a single vector, a process known as data fusion. In one or more implementations, an attention mechanism is applied to measure the significance of the data from each sensor 130. In particular arrangements, the integrated features are input into a fully connected network that distinguishes between normal and anomalous data. In one or more variations, upsampling and segmentation occur if the network detects structural abnormalities, identifying the specific regions of the anomaly in either the thermal or visual image. In some implementations, this identification is achieved by ascertaining which pixels or data the network used to reach its conclusion, employing techniques like GradCam.

In one or more implementations, Multi-Stream CNNs are employed in the unmanned ground vehicle 110’s control system 180. These involve training separate CNNs on data from each type of sensor 130, with their feature maps fused at a particular juncture within the network for feature-level fusion. For instance, visual and thermal data may be processed through distinct streams, and their resultant outputs are merged and routed through fully connected layers for the final classification. Any of the previously mentioned data fusion techniques could be applicable in this context. In particular arrangements, attention mechanisms are employed because they are advantageous when certain sensors may provide more pertinent information contingent on the context. In one or more variants, the network is designed to learn and prioritize the most informative sensor data at any moment, with any of the earlier discussed data fusion techniques being potentially suitable for integration.

Additionally, LSTM/GRU Networks are effective for temporal anomaly detection, such as the ongoing monitoring of structural health. In some implementations, Long Short-Term Memory (LSTM) or Gated Recurrent Unit (GRU) networks handle sequences of sensor 130 readings, which capture time-dependent dependencies and integrate data from multiple sensors 130 by employing distinct LSTM layers for various data types, followed by a fusion process. Here again, any of the data fusion techniques previously delineated could be compatible.

Finally, in various arrangements, transformer networks, wielding their self-attention mechanism, are implemented to discern interrelations amongst different sensors 130 data. In one or more implementations, a transformer treats each sensor 130’s dataset as a separate token within a sequence, thus enabling it to understand the interplay between data from various sensors 130. As with other approaches, any of the aforementioned data fusion techniques could be employed in conjunction with these networks.

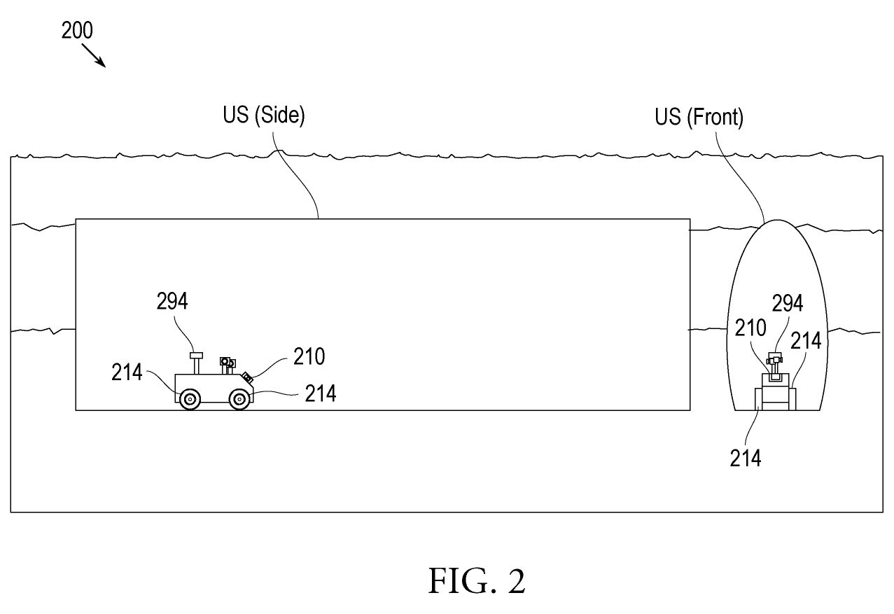

FIG. 2 contains two views 200 of a side and front of an underground structure (US) being inspected by an unmanned ground vehicle 210 (analogous to unmanned ground vehicle 110 in FIG. 1)having steerable wheels 214, equipped with one or more sensors (such as a sensor 130 as shown in FIG. 1), cameras (such as a camera 120 as shown in FIG. 1), and deployable crawlers (such as a deployable crawler 150 as shown in FIG. 1), consistent with one or more embodiments of the present disclosure. In one or more variants, systems consistent with the present disclosure further comprise an indoor positioning system 294 (e.g., a Positioning system or “PS” for short) on or within the unmanned ground vehicle 210 and electrically connected to a control system, such as the control system 180 depicted in FIG. 1. In some implementations, systems consistent with the present disclosure utilize infrared, Wi-Fi, acoustic, or vision-based tracking to position the unmanned ground vehicle 210 within the underground structure (US) for positioning system 294 (discussed further below).

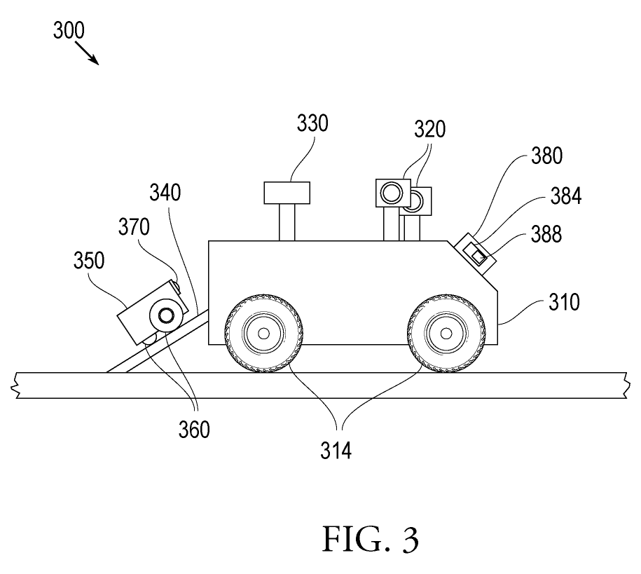

FIG. 3 is a rendering 300 of an unmanned ground vehicle 310 (analogous to unmanned ground vehicle 110 in FIG. 1) equipped with one or more sensors 330, one or more cameras 320, and one or more crawlers 350 being deployed or having already been deployed, consistent with one or more embodiments of the present disclosure. In one or more implementations, an unmanned ground vehicle 310 also contains a deployment ramp 340 for deployment of deployable crawlers, such as deployable crawler 350. Additionally, in one or more implementations, the unmanned ground vehicle 310 comprises a control system 380 (like control system 180 in FIG. 1) that is stationed on or in the unmanned ground vehicle 310. In some implementations, the control system 380 comprises a processor 384, a memory 388, and code stored in the memory 388 and executable in the processor 384.

In one or more variations, systems consistent with the present disclosure further comprise an unmanned ground vehicle 310 equipped with steerable wheels 314. In some implementations, the steerable wheels 314 comprise magnetic wheels, suction wheels, or a combination of both magnetic wheels and suction wheels. In one or more variations, systems consistent with the present disclosure further comprise an unmanned ground vehicle 310 having one or more deployable crawlers 350 that are also equipped with steerable wheels 360 and one or more sensors 370, one or more cameras 370, or a combination of sensors and cameras 370. In some implementations, the steerable wheels 360 comprise magnetic wheels, suction wheels, or a combination of both magnetic wheels and suction wheels. Unmanned ground vehicle 310 and deployable crawler 350 are depicted with 2-by-2 (i.e., four-wheeled) wheel structure, but it will be understood that that each can have any number of wheels 314 and 360 (respectively) as appropriate for various mission parameters, such as 3-by-3, 4-by-4, or even track structures.

In one or more variations, visual inspection serves as a viable method for structural examinations; however, some anomalies prove particularly challenging to discern using visual inspection techniques, especially within underground caverns where detection by the human eye may border on the impossible. In some implementations, systems consistent with the present disclosure incorporate three or more layers of technological innovation using a combination of components as described herein, synthesized into a system engineered to thoroughly and reliably detect interior surface anomalies of subterranean reservoirs, thereby facilitating an evaluation of the condition of the cavern (or other underground structure) walls.

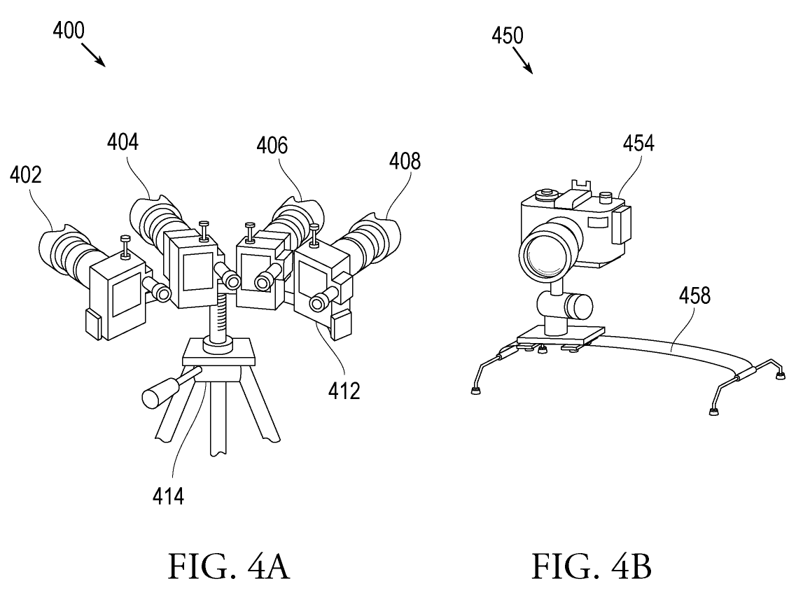

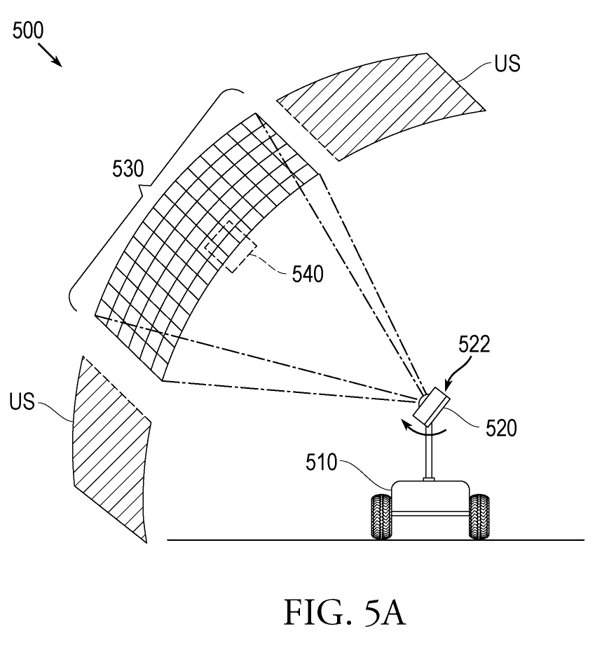

FIG. 4A is a camera array 400 such as those used on an unmanned ground vehicle (like unmanned ground vehicle 110 in FIG. 1), consistent with one or more embodiments of the present disclosure. In one or more variants, the camera array 400 has have one or more cameras (such as 402, 404, 406, and 408). In some variations, the cameras in camera array 400 are of various types, such as high-resolution cameras. In some implementations, the camera array 400 is mounted on a U-shaped rack 412 or arc-shaped rack 412 to provide different angles and conform to the contours of, for example, the underground tank structure. In some implementations, the camera array 400 is mounted on an unmanned ground vehicle using a camera stand 414. However, in other implementations, the cameras are mounted on an unmanned ground vehicle using telescopic poles (such as telescopic pole 160 in FIG. 1).

In one or more variants, the capture of high-resolution images is utilized to obtain detailed graphical records of the interior walls because, in contrast, reliance on the human eye and the sheer volume of data garnered renders traditional anomaly location methods ineffective; hence, multiple implementations consistent with the present disclosure adopt a machine learning-based detection system. In some implementations, detailed images are acquired using multiple cameras (such as cameras 402, 404, 406 and 408) or camera arrays (such as a camera array 400) positioned on an arch-shaped structure 412 that mirrors the curvature of the underground cavern, where the resulting images may be amalgamated, creating a comprehensive panoramic representation—or “slice”—of the interior walls. In one or more variants, this visual data is augmented through the incorporation of a point cloud layer derived from LiDAR technology (described further below) along with thermal imaging to detect defects in the walls which may manifest as temperature disparities caused by the leakage of heat or cold pockets. In some implementations, by creating a comprehensive digital twin of this subterranean asset, this array of data further enables the creation of an accurate three-dimensional model of the infrastructure in question.

FIG. 4B is a sliding camera feature 450 such as those used on an unmanned ground vehicle (like unmanned ground vehicle 110 in FIG. 1), consistent with one or more embodiments of the present disclosure. In one or more implementations, a camera 454 is mounted on a sliding rack 458. In some implementations, the sliding feature is mechanised and controlled by an unmanned ground vehicle control system (such as the control system 180 in FIG. 1). Utilizing a single sliding camera 454 that moves around an arc is advantageous for scanning a cavern or underground structure while the unmanned ground vehicle is moving. In one or more variations, a singular camera 454 is employed to capture a panoramic image, utilizing either a wide-angle camera with a 270-degree or 360-degree field of vision, or alternatively, a single camera 454 endowed with a 110-degree angle affixed to a sliding mechanism 458 that facilitates the creation of panoramic photography.

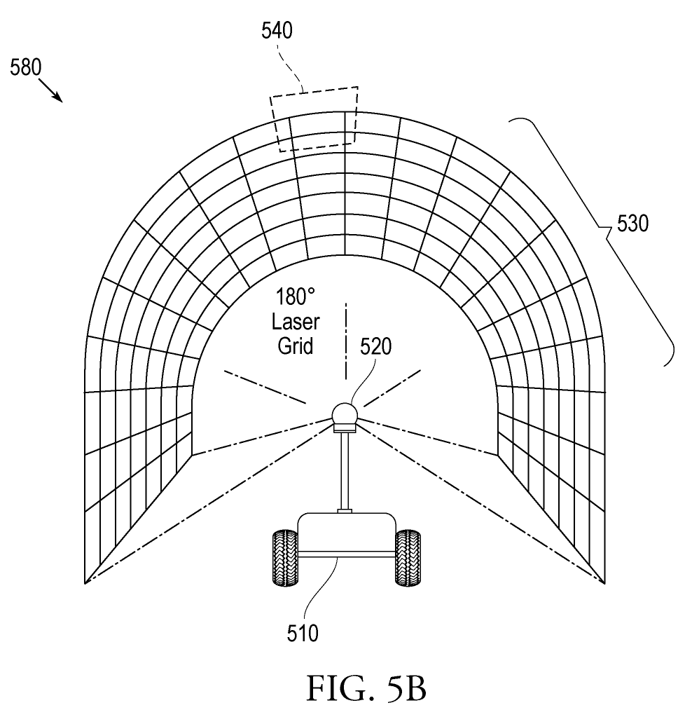

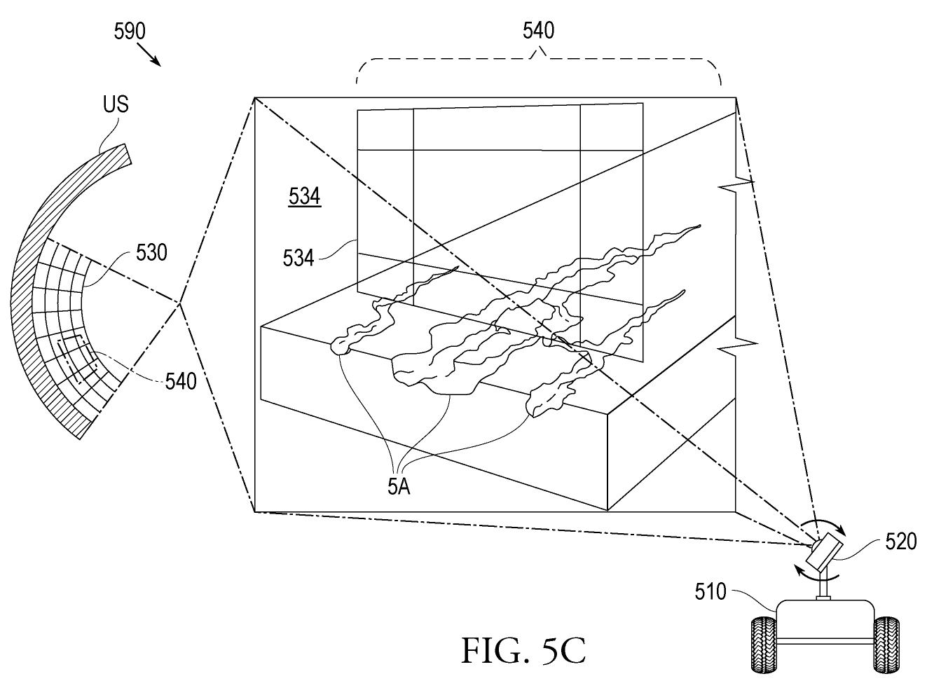

FIG. 5A is a depiction 500 of fractional laser grid 530 cross-section projected from an unmanned ground vehicle 510 (analogous to unmanned ground vehicle 110 in FIG. 1) for inspecting the wall of an underground structure (US), consistent with one or more embodiments of the present disclosure. In one or more variants, systems consistent with the present disclosure further comprise an unmanned ground vehicle 510 equipped with a laser grid projector 520 mounted on a pan-and-swivel tilt mechanism 522. The laser projector 520 is configured to measure a laser grid square unit 540 and transmits signals representing these square units to the unmanned ground vehicle 510 control system (such as control system 180 in FIG. 1) for processing. In some arrangements, an adjustable visual laser grid 530 projector 520 mounted on a controlled pan-tilt mechanism 522 enables outward projection onto an underground structure’s interior walls to detect deformations.

In one or more variations, a fine-grid laser projector 520 is employed to facilitate the detection of surface anomalies by projecting outward from the unmanned ground vehicle 510 or deployable crawler (such as deployable crawler 150 in FIG. 1). In some implementations, the laser projector 520 emits a single line, multiple lines, or a grid pattern (such as grid pattern 530), given that these projections form parallel lines or generate a continuous and uniform series of grid squares (such as grid square 540) that are pre-calibrated and measured. In one or more variants, this method enhances visual inspections by utilizing shadow contrasts to identify cracks, upon which an AI model can be trained to discern and catalog such defects. Additionally, in one or more variants, this method enhances visual inspections by examining the alignment and consistency of the grid squares, upon which an AI model can be trained to discern and catalog such defects.

FIG. 5B is a depiction of a different perspective 580 from that of FIG. 5A and shows a 180-degree laser grid cross-section 530 projected from an unmanned ground vehicle 510 (analogous to unmanned ground vehicle 110 in FIG. 1) laser grid projector 520 mounted on a pan-and-swivel tilt mechanism for inspecting the wall of an underground structure (US), consistent with one or more embodiments of the present disclosure. The laser projector 520 is configured to measure a laser grid square unit 540 and transmits signals representing these square units to the unmanned ground vehicle 510 control system (such as control system 180 in FIG. 1) for processing.

In some implementations, the laser grid 530, whether comprised of extraordinarily fine lines for limited coverage or broader for extensive coverage, features an adjustable resolution that facilitates initial rapid scanning during the early stages of the inspection process. In one or more variants, upon the preliminary detection of an anomaly on the surface, the system is configured by a processor executing code which operates to narrow and refine the grid to improve the granularity of the scan, allowing for precise defect localization and subsequent marking for repair or further evaluation. In one or more variations, the base of the laser grid projector 520 is designed to swivel and pivot using a pan-tilt mechanism 522 or swivel-tilt mechanism 522, redirecting the laser grid 530 focus to specific target locations as required. In some implementations, synchronization is established between the high-resolution camera(s), such as the examples depicted in FIGS. 4A and 4B, and a thermal imaging camera, incorporating them into the layered approach as explicated in the preceding paragraph, thus enabling a comprehensive and multi-faceted inspection protocol.

FIG. 5C is a close-up view 590 of a laser grid cross-section 530 projected from an unmanned ground vehicle 510 (analogous to unmanned ground vehicle 110 in FIG. 1) for inspecting the wall of an underground structure (US), consistent with one or more embodiments of the present disclosure. The laser projector 520 is configured to measure a laser grid square unit 540, and this square unit 540 is shown up close next to structural abnormalities (SA). Laser beam 534 is projected from laser projector 520 onto the underground structure surface, and reflections of the laser beam 534 are measured by a measurement sensor, indicating structural abnormalities such as cracks in the underground structure.

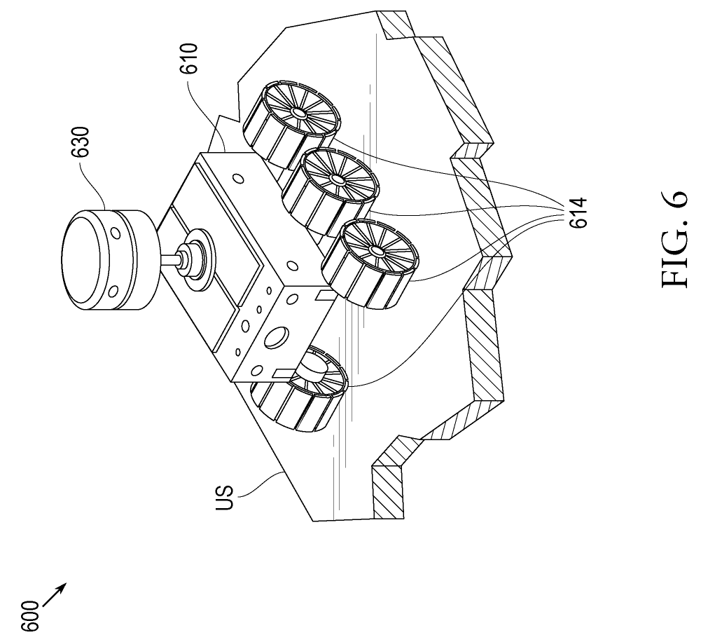

FIG. 6 is a depiction 600 of a LiDAR sensor 630 mounted on an unmanned ground vehicle 610 (analogous to unmanned ground vehicle 110 in FIG. 1) with steerable wheels 614, consistent with one or more embodiments of the present disclosure. In one or more variations, systems consistent with the present disclosure further comprise a LiDAR sensor system 610 that generates point cloud data for generating a map of the underground structure (US). In some implementations, the deployment of both 3D and 2D LiDAR systems is leveraged to accurately map interior details of cavernous structures, enabling the detection of defects and anomalies, with the provision for integrating this data with other measurements over time for a detailed analysis.

In one or more implementations, LiDAR is utilized to measure distances by directing a laser at an object or surface and recording the time it takes for the reflected light to return. In some implementations, by mounting a LiDAR system on the unmanned ground vehicle, point cloud data is generated that reveals the shape of a cavern or underground structure as the vehicle traverses its interior, which, in conjunction with high-resolution imagery, allows for the assembly of a detailed view of the cavern’s interior. In particular arrangements, LiDAR-based information can be applied in two principal manners. In one or more variations, should there be actual fissures penetrating both the wall of the cavern and its interior coating—visible to the LiDAR—the system would likely detect these as recessions in the cavern’s surface, necessitating additional scrutiny. An RGB camera is a camera that captures light in red, green, and blue wavelengths to create colored images. RGB stands for red, green, and blue, which are the primary colors of light used in the RGB color model. In various arrangements, by combining LiDAR data with high-resolution RGB camera imagery, systems consistent with the present disclosure visually confirm anomalies such as cracks, which are typically identified as discolorations against the background of a lighter coating, thereby verifying the defect via both depth and visual cues.

In one or more variants, if the underground structure’s (e.g., cavern’s) coating remains undisturbed due to the narrowness of a crack, both the LiDAR and the RGB cameras might fail to directly register the fault, since both systems primarily measure surface characteristics. However, in various arrangements, a significantly burdened structure experiencing cracking could induce subtle forms of deformation, like warping or shifting. In one or more variations, even in the absence of overt cracking, other forms of corrosion, such as rusting, could instigate material expansion or erosion, thereby altering the geometry of the cavern. In some implementations, the LiDAR sub-system’s role is to map cavern geometry with high precision to search for structural defects or geometric alterations such as these. In one or more implementations, initially all irregularities demand exploration, but in later examinations, it is the changes relative to the previous LiDAR-documented geometry that prompt concern. In one or more variants, this approach provides a method for long-term asset management by facilitating the monitoring of geometric alterations over extended periods.

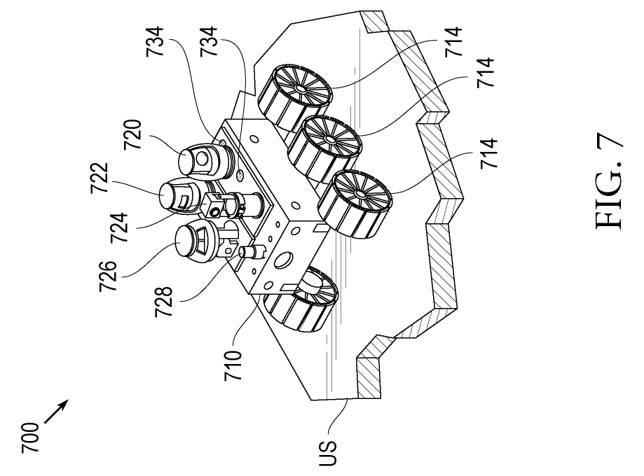

FIG. 7 is a depiction 700 of a series of various types of thermal imaging cameras or sensors (720, 722, 724, 726, and 728) mounted on an unmanned ground vehicle 710 (analogous to unmanned ground vehicle 110 in FIG. 1) having steerable wheels 714 (like the steerable wheels 114 in FIG. 1), as well as acoustic sensors 734, consistent with one or more embodiments of the present disclosure. In some implementations, the unmanned ground vehicle 710 thermal imaging sensors (which comprises one or more of 720, 722, 724, 726, and 728) are configured to produce a thermal map indicating temperature gradients and potential defects within the underground structure (US).

In one or more implementations, thermal imaging as applied in systems consistent with the present disclosure employs infrared cameras such as 720, 722, 724, 726, and 728 to detect temperature variations in structures, revealing elements that are invisible to the naked eye or standard cameras, making it a valuable tool in cavern inspections. In some implementations, the unmanned ground vehicle 710 is equipped with a thermal camera designed to capture thermal imagery, reflecting the spectrum of infrared radiation emanating from the cavern’s surface, thereby generating a thermal map with coordinates that correspond to the wall’s temperature. In particular arrangements, temperature gradients observed in these images expose structural defects such as fractures, weaknesses, voids, and deviations in heat exchange, or they highlight coating anomalies that exhibit distinct signatures detectable by deep learning algorithms.

In various arrangements, thermal imagery is also used to pinpoint potential areas of extensive corrosion as well as the presence of hazardous gases, including methane and hydrogen sulfide (H2S). In one or more variants, these thermal images are subsequently overlaid on comprehensive 3D models that result from sensor data fusion, providing an enhanced analysis of both the structural geometry and thermal characteristics of the cavern. In one or more variations, this layered approach considerably augments the understanding of the cavern’s condition by integrating geometric and temperature data.

In various arrangements, unmanned ground vehicle 710 is equipped with one or more acoustic sensors to measure sound and echo to determine cracks. In one or more variations, detection of cracks in the wall of an underground structure using acoustics is achieved by acoustic sensors 734. In particular arrangements, the system is mounted on an unmanned ground vehicle 710, and a speaker—either directional or multidirectional—will emit a certain sound at a specific frequency. In one or more implementations, the echo that emanates from that sound is recorded and processed in a processor (such as processor 184 in FIG. 1). Cracks are likely to dissipate vibration energy, which slightly lowers recorded acoustic pitch. In one or more variants, machine learning is then utilized by code executing in a processor (such as processor 184 within unmanned ground vehicle 710 control system 180) to distinguish between a healthy area or an area suffering from a crack.

In one or more variants, detection of cracks in the wall is accomplished using acoustics via a traveling wave. In various arrangements, this technique comprises the use of an array of acoustic sensors and transducers situated along the length of the cavern and around the vertical “circumference” of its walls, ceiling, and potentially the floor if needed. In some implementations, this concept involves generating an acoustic wave and monitoring its reflective broadcast through the walls of the cavern, monitoring for and recording (via the acoustic sensors) any reflections or delays indicating damage, cracking, or other variations in the condition of the walls.

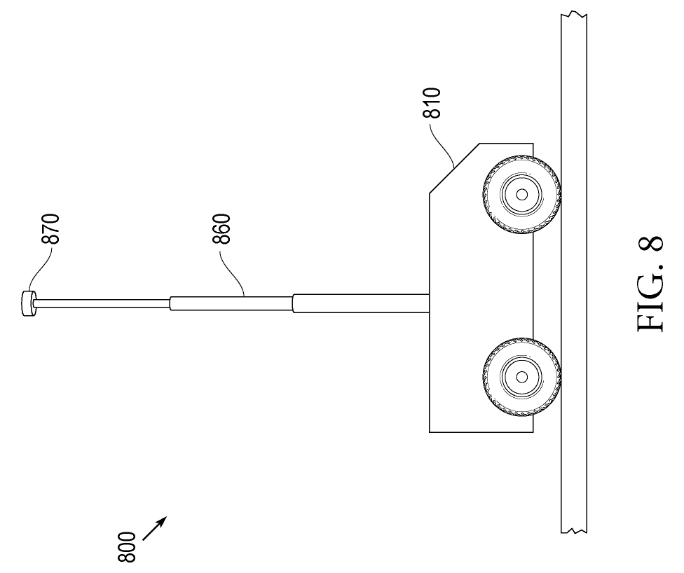

FIG. 8 is an example 800 of a telescopic pole 860 (like telescopic pole 160 in FIG. 1) mounted on an unmanned ground vehicle 810 (analogous to unmanned ground vehicle 110 in FIG. 1), consistent with one or more embodiments of the present disclosure. In some implementations, the telescopic pole 860 is configured to lift one or more cameras (such as the camera 120 in FIG. 1) into proximity of the underground structure.

In one or more implementations, the attachment of an electric telescopic pole 860 or mast enables a 360-degree array of cameras to capture comprehensive visuals of the underground structure’s (e.g., cavern’s) interior for inspection purposes. In some implementations, the electric telescopic pole 860 or mast possesses the capability to extend to the midpoint of the cavern and initiate the inspection utilizing technologies as previously delineated. In particular arrangements, the imaging process can occur either while the electric telescopic pole 860 or mast is in motion or it may pause at designated intervals—for instance, halting every few meters to carry out a scan or capture a “slice” of the circumferential area. In various arrangements, this electric telescopic pole 860 or mast operation can be conducted in conjunction with other sensors (such as sensors 130 in FIG. 1) that are affixed to the unmanned ground vehicle 810, enabling parallel data acquisition. In one or more variants, it is advantageous to equip the vehicle with environmental sensors (such as gas detection sensors) to ensure that inspection conditions within the area are safe. In one or more variations, stand 870 at the top of the pole 860 or mast has the potential to accommodate a camera or an ensemble of cameras, a thermal sensor, an acoustic sensor, LiDAR, or any other requisite sensors for the assessment of defects.

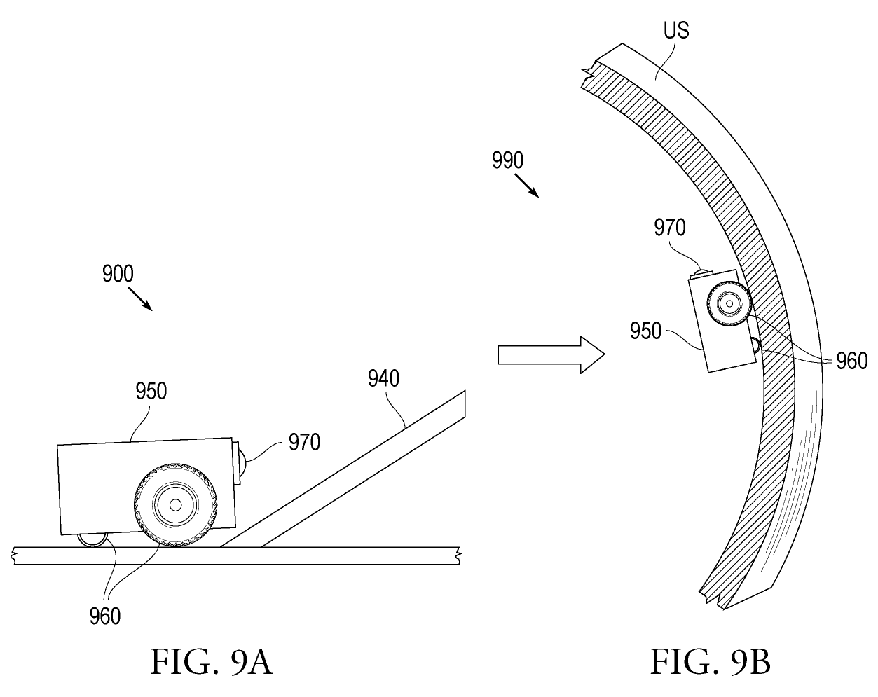

FIG. 9A is a depiction 900 of a deployable crawler 950 (like deployable crawler 150 in FIG. 1 and crawler 350 in FIG. 3) descending an unmanned ground vehicle’s ramp 940 (like the unmanned ground vehicle 310’s ramp 340 in FIG. 3), consistent with one or more embodiments of the present disclosure. In one or more implementations, the deployable crawler or crawlers 950 further comprise magnetic wheels 960, suction wheels 960, or a combination of both magnetic wheels and suction wheels. In some implementations, a deployable crawler 950 is equipped with a combination of sensors, such as a sensor 970, selected from the group consisting of ultrasonic testing (UT) probes, eddy current sensors, and terahertz sensors.

In one or more implementations, after the unmanned ground vehicle (like unmanned ground vehicle 110 in FIG. 1 or unmanned ground vehicle 310 in FIG. 3, for example) identifies and marks a site of interest, it transmits the coordinates to a crawler 950, which is deployed as the ramp 940 lowers. In some variations, the crawler 950 proceeds to a spot designated by the unmanned ground vehicle detection system. In particular arrangements, the crawler 950 performs an inspection utilizing one or a combination of the following preselected technological methods.

In one or more variations, one such method involves the use of an ultrasonic testing (UT) probe to gauge the thickness of metal sheets. In some implementations, this may incorporate a dry coupling UT sensor with capabilities to cover a more extensive area. In some variations, the crawler 950 is designed to move at a speed of 10 to 20 centimeters per second, which is synchronized with the operating frequency of the UT sensor 970. In various arrangements, the choice of wheels 960—either magnetic or suction-based—depends on the wall material: magnetic wheels adhere to metallic surfaces while suction wheels function on non-metallic materials. This concept may be analogously employed in the subsequent methods as well.

In various arrangements, a second crawler 950 sensing method employs an eddy current sensory system for detecting cracks underneath coatings. In one or more variants, the incorporation of an eddy current sensor onto a robotic crawler 950 grants significant autonomy to the inspection process, necessitating that the sensor probe 970 remains as close to the potential defect as feasible. In particular arrangements, this is accomplished by mounting the sensor 970 on an adjustable telescopic pole (similar to the unmanned ground vehicle 810’s telescopic pole 860 in FIG. 8), or on an unmanned ground vehicle or crawler 950 that is nimble enough to approach the anomaly previously pinpointed via a long-range detection technique. In one or more variations, the sensor 970 could also be integrated into the wheels 960, allowing the crawler 950 to passively scan for any irregularities on the surface of the underground structure as it traverses, for example, the cavern floor or other portions.

In one or more implementations, a third crawler 950 sensing method utilizes terahertz (THz) sensing technology for examination of the internal walls of underground caverns. In various arrangements, THz waves are adept at analyzing multi-layer structures and identifying diverse anomalies such as the presence of foreign materials, disbonds, delaminations, mechanical impact damage, heat damage, and moisture penetration. In one or more variants, the THz sensor 950 is mounted on a controllable platform, such as a telescopic pole of an unmanned ground vehicle (similar to the unmanned ground vehicle 810’s telescopic pole 860 in FIG. 8) or crawler 950, enabling the THz sensor to access and investigate the defect with greater precision than long-range assessment methods can offer.

FIG. 9B is a depiction 990 of a deployable crawler 950 scaling and attached to the interior wall of an underground structure (US) having an exemplary metallic surface, consistent with one or more embodiments of the present disclosure. The deployable crawler 950’s magnetic wheels 960, suction wheels 960, or a combination of both magnetic wheels and suction wheels enables it to remain attached to, and to traverse, the magnetic surface of the underground structure (US).

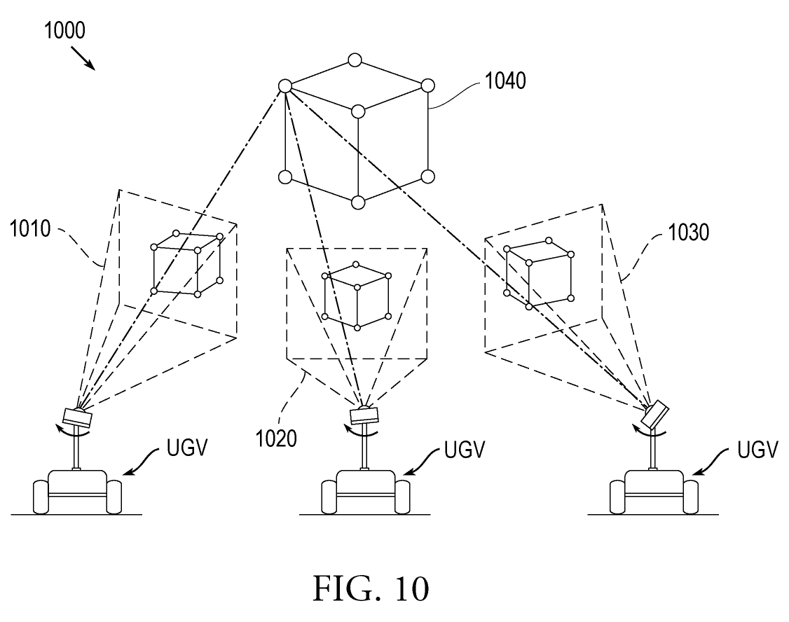

FIG. 10 is an application of Structure from Motion (“SfM”) analysis performed by an unmanned ground vehicle and optionally one or more deployable crawlers, consistent with one or more embodiments of the present disclosure. In one or more variants, systems consistent with the present disclosure further comprise an unmanned ground vehicle (like the unmanned ground vehicle 110 in FIG. 1) with one or more additional deployable crawlers (like deployable crawler 150). In some implementations, the unmanned ground vehicle 110, the first deployable crawler 150, and any additional deployable crawlers 150 are configured to operate simultaneously. In one or more variations, the multiple crawlers 150 are configured to synchronize their movements.

In one or more implementations, Structure from Motion (SfM) can be applied to construct the 3D structure of the underground structure (e.g., cavern) from the sequence of 2D high-resolution images acquired by the unmanned ground vehicle. In particular arrangements, this methodology is well-suited for cavern inspections, where traditional surveying techniques face difficulties due to accessibility and lighting issues. In one or more variants, the process begins with the unmanned ground vehicle capturing images of the cavern’s structure from various viewpoints (such as 1010, 1020, and 1030) and ensuring some overlap between them. In various arrangements, feature extraction methods such as edges, SIFT, or SURF are utilized in each image to identify features, which are then matched across different frames to find common points.

In one or more variations, these matched features allow determination of the orientation and position of the camera (such as camera 120 in FIG. 1) relative to one another. In some implementations, a sparse 3D point cloud 1040 that represents the internal structure of the cavern is generated, which is subsequently densified using multi-view stereo algorithms to create a more detailed model of the internal structures of the cavern. In one or more arrangements, the quality of the 3D models is enhanced by combining LiDAR data with depth cameras, which provide additional depth data where texture information is sparse.

In various arrangements, deep learning algorithms are deployed to compute depths directly from the high-resolution images, thereby aiding in the creation of an accurate and detailed 3D model of the cavern. In one or more variants, these algorithms, leveraging large datasets of 2D images, estimate the corresponding 3D structure within the image by inferring depth with quantifiable precision. In one or more variations, the resulting 3D model bolsters structural analysis of the cavern’s walls and assists in the identification of cracks, deformations, and other irregularities. In some implementations, the production of accurate geological maps of the cavern is facilitated, simplifying the analysis and inspection processes. In one or more arrangements, the integration of SfM with LiDAR and depth cameras, in addition to the utilization of deep learning for depth estimation, ensures the generation of accurate 3D models of the caverns that are essential for comprehensive evaluations.

In some implementations, positioning of the unmanned ground vehicle and crawlers through three-dimensional modeling of caverns or underground structures (US) is achieved using a structure from motion (“SfM”) approach, which combines data from various sensors on the unmanned ground vehicle 110 and deployable crawler or crawlers 150 to create precise, detailed models of the inspected areas. Some industrial environments abound with metal and hamper the acquisition of global positioning system (“GPS”) and magnetic signals, leading unmanned vehicles to potentially endure positioning loss due to sensor drift in the Inertial Measurement Unit (IMU). In particular arrangements, considering that LiDAR can achieve sub-millimeter precision and such accuracy is coveted for inspections, it becomes imperative to ascertain the unmanned ground vehicle’s location and movement with comparable precision, allowing Structure from Motion (SfM) algorithms to construct structural data of similar resolution. In various arrangements, while achieving marginally higher resolution in the SfM output than the positioning accuracy of the unmanned vehicle is conceivable, it would substantially augment the computational resources required for precise alignment and amplify the risk of erroneous results.

In order to surmount this obstacle, various systems consistent with the present disclosure incorporate an indoor/local positioning system (such as positioning system 294 in FIG. 2). In some implementations, various technological avenues are utilized for this positioning system 294, incorporating technologies including but not limited to infrared (IR), Wi-Fi/Radio, Acoustic, and Vision/Camera-based methods. In one or more variants, these methods are founded on the principle that at least one (typically three or more) reference points (such as 1010, 1020, and 1030) are established, after which the unmanned ground vehicle’s location is continuously monitored relative to these points, thus ensuring high-resolution tracking of the unmanned ground vehicle. In one or more variations, external reference points could also facilitate tracking the unmanned ground vehicle, which is beneficial for precision in docking maneuvers. In various arrangements, markers could be strategically affixed to specific locales along the underground structure (e.g., tank) walls—a routine procedure in SfM operations—providing concrete ground truth coordinates. These markers are, in some implementations, permanently emplaced within the tanks, serving to offer ground truth validations of the structural fidelity across successive inspection iterations.

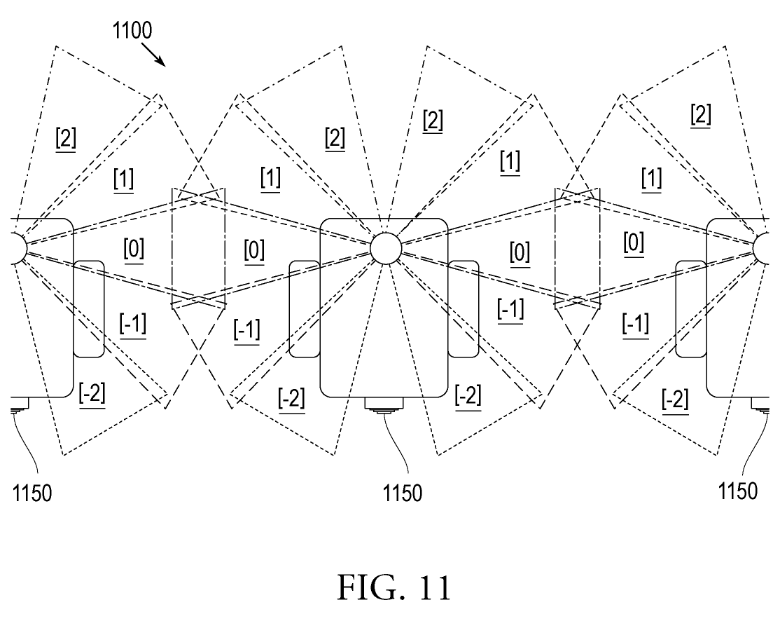

FIG. 11 is a set 1100 of multiple deployable crawlers 1150 conducting a synchronized dynamic scan of an underground structure, consistent with one or more embodiments of the present disclosure. In one or more variations, the unmanned ground vehicle (such as unmanned ground vehicle 110 in FIG. 1) houses not only one but multiple crawlers 1150 (like crawler 150 in FIG. 1) to expedite the completion of a contact-based inspection mission. In various arrangements, these crawlers 1150 operate in parallel and coordinate their movements in real time to conduct a dependable full scan.

In one or more implementations, a set of n crawlers 1150 may be used simultaneously to provide a methodical means of executing any of the previously mentioned methods or steps, which includes the integration of multiple infrared (IR) sensors on each crawler 1150. In particular arrangements, the sensors enable the adjacent crawlers 1150 to ascertain the positions of the crawlers to their left and right. In some implementations, the zones, numbered from [-2 to 2] in FIG. 11, serve as indicators for each crawler on the necessary motion adjustments, such as speeding up or slowing down, to maintain an aligned scanning front for all crawlers 1150 and to ensure synchronization in the data acquisition.

Returning briefly to FIG. 1 and with reference to additional figures, in some implementations, a method is depicted for inspecting underground structures (US) using an unmanned ground vehicle 110. In one or more variants, the method comprises navigating the unmanned ground vehicle 110 autonomously along the length of the underground structure using a plurality of sensors 130. In some implementations, the sensors 130 comprise a combination selected from the group consisting of cameras 120, LiDAR 630 (from FIG. 6), and thermal imaging sensors 720 (from FIG. 7). In one or more variations, the method involves deploying, upon detection of anomalies in the underground structure by the unmanned ground vehicle sensors 130, a first deployable crawler 150 from the unmanned ground vehicle. In some implementations, the first deployable crawler 150 is equipped with a combination of sensors 170 selected from the group consisting of an ultrasonic testing (UT) probe, an eddy current sensor, and a terahertz sensor.

In one or more variants, the method involves analyzing data received from the sensors 130 mounted on the unmanned ground vehicle and the sensors 170 of the first deployable crawler. In some implementations, the step of analyzing is performed using a control system 180 with a processor 184, a memory 188, and code. In one or more variations, the processor 184 is configured to execute one or more machine learning algorithms. In some implementations, the method comprises outputting one or more control signals configured to direct the unmanned ground vehicle 110 and the first deployable crawler 150 to one or more areas of interest within the underground structure (US). In one or more variants, the method comprises coordinating the simultaneous operation of the unmanned ground vehicle 110, the first deployable crawler 150, and any additional deployable crawlers 150 to synchronize their movements and data collection processes.

Again with reference to FIG. 1, in one or more variations, a method or methods disclosed herein further comprises adhering the unmanned ground vehicle 110 or deployable crawler(s) 150 to surfaces of the underground structure (US). In some implementations, the unmanned ground vehicle 110 is equipped with steerable wheels 114 comprising at least one of magnetic wheels or suction wheels as required by a surface material of the underground structure. In one or more variants, a method or methods disclosed herein further comprises extending a telescopic pole 160 with one or more cameras from the unmanned ground vehicle 110 to capture images of the underground structure. In some implementations, a method or methods disclosed herein involves deploying a laser grid projector 520 (such as in FIG. 5A) mounted on a pan-tilt mechanism 522 (from FIG. 5A) from the unmanned ground vehicle 110 to project one or more laser grids 530 on the walls of the underground structure to detect surface deformations. In one or more variations, a method or methods disclosed herein comprises generating, via code executing in the control system 180 processor 184, LiDAR point cloud data to construct a map of the underground structure. In some implementations, a method or methods disclosed herein comprises generating a thermal map using thermal imaging sensors (such as thermal camera 720) to identify temperature gradients and potential defects within the underground structure.

In one or more variants, a method or methods disclosed herein involves positioning the unmanned ground vehicle 110 within the underground structure with a positioning system 294 (as in FIG. 2). In some implementations, the positioning system 294 utilizes at least one of infrared tracking, Wi-Fi tracking, acoustic tracking, or vision-based tracking. In one or more variations, a method or methods disclosed herein comprises capturing sound wave propagation data with acoustic sensors 130 mounted on the unmanned ground vehicle 110. In some implementations, the coordinating step of the method further comprises commanding multiple deployable crawlers 150 initially carried by the unmanned ground vehicle 110 to independently inspect different sections of the underground structure upon deployment. In one or more variants, a method or methods disclosed herein involves constructing a three-dimensional model of the underground structure using data collected from one or more of the cameras 120, LiDAR 630 (from FIG. 6), and sensors 130. In some implementations, a method or methods disclosed herein comprises monitoring for environmental hazards in the underground structure via one or more gas detection sensors 130. In one or more variations, the method provides updates on one or more environmental conditions within the underground structure via signals relayed to the control system 180 by the gas detection sensors 130.

It is to be understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

1. An inspection system for an underground structure, comprising:
an autonomous unmanned ground vehicle;
a plurality of sensors mounted on the unmanned ground vehicle,
wherein the sensors comprise a combination selected from the group consisting of the following: cameras, LiDAR, and thermal imaging sensors;
a first deployable crawler carried by the unmanned ground vehicle,
wherein the first deployable crawler is equipped with a combination of sensors selected from the group consisting of the following: ultrasonic testing (UT) probes, eddy current sensors, and terahertz sensors; and
a control system,
wherein the control system comprises a processor, a memory, and code stored in the memory and executable in the processor,
wherein the control system is configured, via code executing in the processor, to output one or more control signals configured to autonomously navigate the unmanned ground vehicle along the length of the underground structure and deploy the first deployable crawler in response to detection of anomalies in the underground structure, and
wherein the processor is equipped with a machine learning algorithm operative to analyze data received from one or more of the unmanned ground vehicle sensors, the first deployable crawler sensors, or both.

2. The system of claim 1, wherein the unmanned ground vehicle is equipped with steerable wheels, and wherein the steerable wheels further comprise magnetic wheels, suction wheels, or a combination of both magnetic wheels and suction wheels.

3. The system of claim 1, further comprising a telescopic pole mounted on the unmanned ground vehicle, wherein the telescopic pole is configured to lift one or more cameras into proximity of the underground structure.

4. The system of claim 1, wherein the control system machine learning algorithm is configured to analyze images received by the processor in order to detect anomalies.

5. The system of claim 1, wherein the LiDAR system generates point cloud data, and wherein the control system is further configured by code to generate a map of the underground structure.

6. The system of claim 1, wherein the unmanned ground vehicle thermal imaging sensors are configured to produce a thermal map indicating temperature gradients and potential defects within the underground structure.

7. The system of claim 1, further comprising an indoor positioning system configured to utilize infrared, Wi-Fi, acoustic, or vision-based tracking in order to position the unmanned ground vehicle with the underground structure.

8. The system of claim 1, wherein the unmanned ground vehicle further comprises one or more acoustic sensors configured to capture sound wave data.

9. The system of claim 1, wherein the unmanned ground vehicle has one or more additional deployable crawlers,
wherein the unmanned ground vehicle, the first deployable crawler, and any additional deployable crawlers are configured to operate simultaneously,
and wherein the multiple crawlers are configured to synchronize their movements.

10. A method for inspecting an underground structure using an autonomous unmanned ground vehicle, the method comprising:
navigating the unmanned ground vehicle autonomously along the length of the underground structure using a plurality of long-range sensors comprising a combination selected from the group consisting of the following: cameras, LiDAR, and thermal imaging sensors;
deploying, upon detection of anomalies in the underground structure by the unmanned ground vehicle sensors, at least a first deployable crawler from the unmanned ground vehicle equipped with a combination of short-range sensors selected from the group consisting of the following: an ultrasonic testing (UT) probe, an eddy current sensor, and a terahertz sensor;
analyzing, data received from the sensors mounted on the unmanned ground vehicle and the first deployable crawler,
wherein the step of analyzing is performed using a control system with a processor, a memory, and code, and
wherein the processor is configured to execute a machine learning algorithm;
outputting one or more control signals configured to direct the unmanned ground vehicle and the first deployable crawler to one or more areas of interest within the underground structure; and
coordinating the simultaneous operation of the unmanned ground vehicle, the first deployable crawler, and any additional deployable crawlers to synchronize their movements and data collection processes.

11. The method of claim 10, further comprising the following steps:
navigating the unmanned ground vehicle autonomously along the underground structure with one or more of the long-range sensors in an active inspection mode;
pausing the active inspection mode upon detection of an anomaly by the long-range sensors;
deploying at least one deployable crawler equipped with one or more of the close-range sensors in response to the detected anomaly;
conducting a close-range inspection of the detected anomaly by the deployable crawler;
returning the deployable crawler to the unmanned ground vehicle after the close-range inspection is completed;
docking the deployable crawler in the unmanned ground vehicle; and
resuming the active inspection mode with the long-range sensors for continued navigation along the underground structure after the deployable crawler has docked.

12. The method of claim 10, further comprising the steps of selecting at least one of magnetic wheels and suction wheels to equip the unmanned ground vehicle, and adhering the unmanned ground vehicle to surfaces of the underground structure, and wherein the selection step is a function of a surface material of the underground structure.

13. The method of claim 10, further comprising the step of extending a telescopic pole with one or more cameras from the unmanned ground vehicle mounted thereupon to capture images of the underground structure at a telescoping distance from the unmanned ground vehicle.

14. The method of claim 10, further comprising the step of deploying a laser grid projector mounted on a pan-tilt mechanism from the unmanned ground vehicle to project laser grids on the walls of the underground structure to detect surface deformations.

15. The method of claim 10, further comprising the steps of generating, via code executing in the control system processor, LiDAR point cloud data to construct a map of the underground structure and generating a thermal map using thermal imaging sensors to identify temperature gradients and potential defects within the underground structure.

16. The method of claim 10, further comprising the step of positioning the unmanned ground vehicle within the underground structure with a positioning system, wherein the positioning system utilizes at least one of infrared tracking, Wi-Fi tracking, acoustic tracking, or vision-based tracking.

17. The method of claim 10, further comprising the step of capturing sound wave propagation data with acoustic sensors mounted on the unmanned ground vehicle.

18. The method of claim 10, wherein the coordinating step further comprises commanding multiple deployable crawlers initially carried by the unmanned ground vehicle to independently inspect different sections of the underground structure upon deployment.

19. The method of claim 10, further comprising the step of constructing a three-dimensional model of the underground structure using data collected from one or more of the cameras, LiDAR, and sensors.

20. The method of claim 10, further comprising the steps of monitoring, via one or more gas detection sensors, for hazardous gases, and providing, via signals relayed to the control system by the gas detection sensors, updates on one or more environmental conditions within the underground structure.
